(19) United States
(12) Patent Application Publication
(10) Pub. No.: US 2023/0297031 A1
(43) Pub. Date: Sep. 21, 2023

(54) Timepiece Component Decoration Method And Timepiece Component

(71) Applicant: SEIKO EPSON CORPORATION, Tokyo (JP)

(72) Inventors: Toshinori NAKAZAWA, Matsumoto (JP); Hironori HASEI, Azumino (JP); Toshimitsu HIRAI, Hokuto (JP); Hirofumi KUROSAWA, Tatsuno (JP)

(21) Appl. No.: 18/184,397

(22) Filed: Mar. 15, 2023

(30) Foreign Application Priority Data
Mar. 16, 2022 (JP) 2022-041090

(51) Int. Cl. G04B 45/00; G04B 19/12

(52) U.S. Cl. CPC G04B 45/0076; G04B 19/12

(57) ABSTRACT

A timepiece component decoration method includes a base formation step of forming a pattern shape on a base material of a timepiece component and using the pattern shape as a base, a first light-transmissive layer formation step of forming, on a surface of the base, a first light-transmissive layer using a light-transmissive resin, a first liquid repellent treatment step of performing a liquid repellent treatment on a surface of the first light-transmissive layer, and a first printed layer formation step of, to form a first printed layer, ejecting ink and printing a pattern shape by an inkjet method on the surface of the first light-transmissive layer on which the liquid repellent treatment was performed, after the first liquid repellent treatment step.

The present application is based on, and claims priority from JP Application Serial Number 2022-041090, filed Mar. 16, 2022, the disclosure of which is hereby incorporated by reference herein in its entirety.

### BACKGROUND

### 1. Technical Field

The present disclosure relates to a timepiece component decoration method and a timepiece component.

### 2. Related Art

WO 01/15123 discloses a method of forming surface pattern shapes of various designs by providing an ink-receiving layer on the surface of a display plate such as a dial of a timepiece and performing printing by an inkjet method in which ink droplets are ejected onto the ink-receiving layer.

The ink-receiving layer is configured using a porous layer or a water-absorbing layer made of an inorganic compound or an organic compound, and thus the ejected ink droplets are absorbed by the ink-receiving layer and spread. For this reason, a planar design printed by an inkjet method can be formed at the display plate, but a complex design having a stereoscopic effect and a depth cannot be formed.

### SUMMARY

A timepiece component decoration method according to the present disclosure includes a base formation step of forming a pattern shape on a base material of a timepiece component and using the pattern shape as a base, a first light-transmissive layer formation step of forming, on a surface of the base, a first light-transmissive layer using a light-transmissive resin, a first liquid repellent treatment step of performing a liquid repellent treatment on a surface of the first light-transmissive layer, and a first printed layer formation step of, to form a first printed layer, ejecting ink and printing a pattern shape by an inkjet method on the surface of the first light-transmissive layer on which the liquid repellent treatment was performed, after the first liquid repellent treatment step.

A timepiece component of the present disclosure includes a base material having on which a pattern shape used as a base is formed, a first light-transmissive layer formed on the surface of the base material from a light-transmissive resin, a first liquid repellent layer formed by performing a liquid repellent treatment on a surface of the first light-transmissive layer, and a first printed layer formed by printing a pattern shape on a surface of the first liquid repellent layer by an inkjet method.

### BRIEF DESCRIPTION OF THE DRAWINGS

FIG. 1 is a cross-sectional view illustrating a layer configuration of a dial which is a timepiece component according to a first embodiment.

FIG. 2 is a flowchart illustrating a method of decorating the dial which is the timepiece component according to the first embodiment.

FIG. 3 is a diagram illustrating reflected light when the dial according to the first embodiment is viewed in a front view.

FIG. 4 is a diagram illustrating reflected light when the dial according to the first embodiment is viewed in a perspective view.

FIG. 5 is a diagram illustrating the dial when viewed in a front view, a perspective view when viewed at 50 degrees, and a perspective view when viewed at 80 degrees.

FIG. 6 is a cross-sectional view illustrating a layer configuration of a dial which is a timepiece component according to a second embodiment.

FIG. 7 is a flowchart illustrating a method of decorating the dial which is the timepiece component according to the second embodiment.

FIG. 8 is a cross-sectional view illustrating a layer configuration of a dial which is a timepiece component according to a third embodiment.

FIG. 9 is a flowchart illustrating a method of decorating the dial which is the timepiece component according to the third embodiment.

### DESCRIPTION OF EXEMPLARY EMBODIMENTS

### First Embodiment

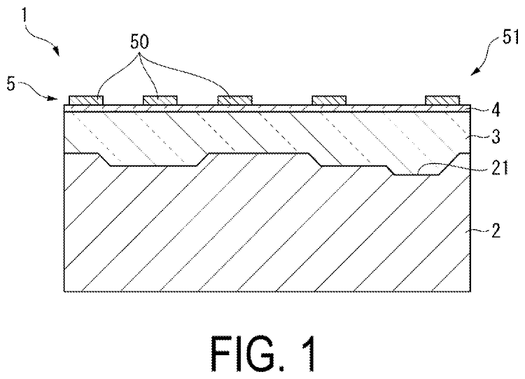

A timepiece component decoration method and a timepiece component according to a first embodiment will be described with reference to FIGS. 1 to 5.

FIG. 1 is a cross-sectional view illustrating a dial 1 which is an example of a timepiece component.

The dial 1 includes a base material 2 having a pattern shape 21 serving as a base formed at a surface thereof, a first light-transmissive layer 3 layered on the surface of the base material 2, a first liquid repellent layer 4 formed by performing a liquid repellent treatment on the surface of the first light-transmissive layer 3, and a first printed layer 5 formed at the surface of the first liquid repellent layer 4 using ink 50 ejected by an inkjet method. The first printed layer 5 is formed by printing a pattern shape 51 by changing the density of dots of the ink 50. That is, the pattern 51 of the first printed layer 5 is formed by a dot pattern which is an ejection pattern of the ink 50.

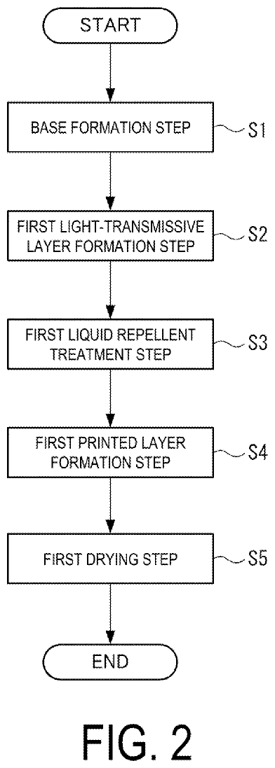

Next, a decoration method for forming a pattern shape at the dial 1 will be described with reference to a flowchart of FIG. 2.

When a decoration method for the dial 1 is started, first, a base formation step S1 of forming the pattern shape 21 on the surface of the base material 2 of the dial 1 by plating, engraving, coating, or the like and using the pattern shape 21 as a base is performed. As the base material 2, a metal plate such as brass, nickel silver, aluminum, or stainless steel, a hard plastic plate, a ceramic plate, or the like can be used, and in particular, when the base material 2 is constituted by a metal plate, the base material 2 can be designed to have a higher class feeling than in a case where plastic is used, and it is possible to further improve a design property by a combination of the pattern shape 21 of the base material 2 and the pattern shape 51 of the first printed layer 5.

Further, in a case where the pattern 21 is formed by providing irregularities on the surface of the base material 2 by engraving or the like, a base in which the pattern shape 21 is formed is configured by an irregular surface of the base material 2. In a case where the pattern shape 21 is formed at the surface of the base material 2 by plating, coating, or the like, a base is constituted by a plated or coated layer.

After the base formation step S1 is performed, a first light-transmissive layer formation step S2 for forming the first light-transmissive layer 3 by applying a light-transmissive resin to the surface of the base material 2 is performed. As the light-transmissive resin, resin materials such as transparent, pearlescent, and colored transparent resin materials can be used, and for example, an acrylic resin, an epoxy resin, or the like can be used. A thickness dimension of the first light-transmissive layer 3 is, for example, 40 μm or more and 100 μm or less.

As a method of applying a light-transmissive resin to the surface of the base material 2, a method of applying a light-transmissive resin by spraying, a method of ejecting and applying a light-transmissive resin by an inkjet method, or the like can be used.

After the first light-transmissive layer formation step S2 is performed, a first liquid repellent treatment step S3 for performing a liquid repellent treatment on the surface of the first light-transmissive layer 3 is performed. For the liquid repellent treatment, for example, a method of replacing a portion of a molecular structure of a resin exposed on the surface of the first light-transmissive layer 3 with fluorine using an atmospheric-pressure plasma may be performed. The first liquid repellent layer 4 having liquid repellent properties is formed at the surface of the first light-transmissive layer 3 by such a liquid repellent treatment.

After the first liquid repellent treatment step S3 is performed, a first printed layer formation step S4 for printing the pattern shape 51 on the surface of the first liquid repellent layer 4 by an inkjet method to form the first printed layer 5 is performed. As the ink 50 ejected by an inkjet method in order to form the first printed layer 5, water-based ink, solvent-based ink, UV curing system ink, or the like can be used. In the ink 50, pigments, dyes, microparticles, resins, and the like are dispersed in a solvent, and for example, silver nanoparticle ink which is a water-based ink, epoxy resin ink which is a solvent-based clear ink, titanium oxide ink which is a solvent-based white ink, carbon ink which is a solvent-based black ink, or the like can be used. In addition, as the ink 50, transparent ink such as titanium oxide ink may be used, or non-transparent ink such as silver nanoparticle ink may be used.

Dots of the ink 50 which are ejected by an inkjet method and attached to the surface of the first liquid repellent layer 4 are formed in a circular shape in a front view when viewed from a direction orthogonal to the surface of the dial 1. The diameter of the dot of the ink 50 has a size of 10 μm or more and 70 μm or less, and preferably has a size of 20 μm or more and 50 μm or less. When the diameter of the dot of the ink 50 has a size of 70 μm or less, one dot itself is printed with a dot size that cannot be visually recognized by a user's naked eye, and thus, when the user visually recognizes the pattern shape 51 of the first printed layer 5, the dots are visually recognized as an aggregate of dots, that is, pattern shapes of dot patterns. In addition, when the diameter of the dot of the ink 50 is 10 μm or more, the ink 50 can be stably ejected to an accurate position by an inkjet method. For this reason, for example, the ink 50 can be repeatedly ejected to the same position.

The thickness dimension of the first printed layer 5, that is, the thickness dimension of the ink 50, is, for example, 0.1 μm or more and 10 μm or less.

After the first printed layer formation step S4 is performed, a first drying step S5 for drying the ink 50 of the first printed layer 5 is performed. In the first drying step S5, the ink 50 is dried using a hot plate, an oven, a far-infrared heating furnace, a vacuum dryer, or the like. Note that, in a case where the ink 50 is UV curing system ink, the ink 50 is cured by UV irradiation in the first drying step S5. That is, the first drying step S5 is a step of fixing the ink 50 attached to the surface of the first liquid repellent layer 4 to the surface of the first liquid repellent layer 4 by drying and curing.

### Visual Effect of Dial

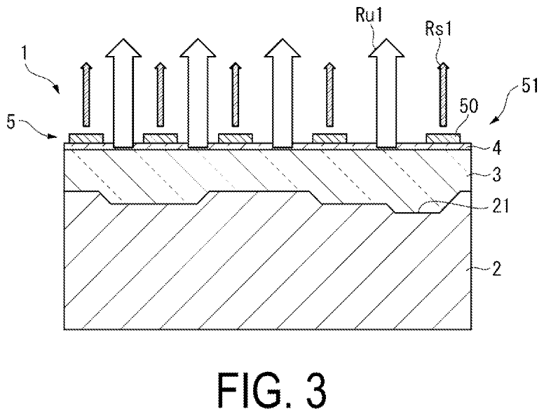

The appearance of a pattern shape when the dial 1 decorated in the above-described steps is visually recognized will be described with reference to FIGS. 3 to 5. In the present embodiment, the dial 1 is provided with the pattern shape 21 formed at the surface of the base material 2 and the pattern shape 51 formed by a dot pattern which is an ejection pattern of the ink 50 of the first printed layer 5. Further, when comparing the front view of the dial 1 from a direction of 0 degrees which is a direction orthogonal to the surface and the perspective view of the dial 1 from an oblique direction, the pattern shape 21 of the base material 2 is more likely to be visually recognized in the front view than in the perspective view, and conversely, the pattern shape 51 of the first printed layer 5 is more likely to be visually recognized in the perspective view than in the front view.

The visual effects are based on the following three reasons. The first reason is because Ls1<Ls2 when the luminance of reflected light Rs1 in a direction of 0 degrees in the first printed layer 5 is Ls1, and the luminance of reflected light Rs2 in an oblique direction is Ls2.

The second reason is because Ls/Lu is larger in the perspective view than in the front view when the luminance of the first printed layer 5 is Ls, and the luminance of the base material 2 is Lu.

The third reason is because the area of the dots of the ink 50 with respect to the exposed area of the base material 2 is larger in the perspective view than in the front view.

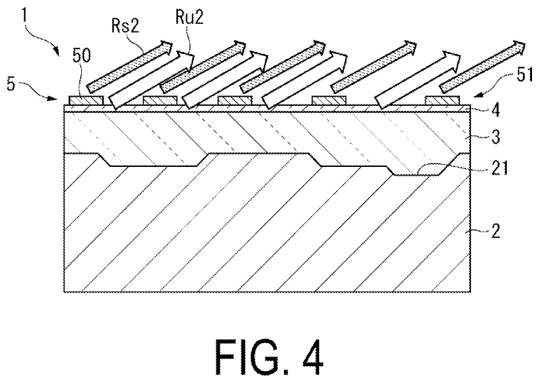

As illustrated in FIGS. 3 and 4, the luminance of reflected light of the first printed layer 5 is lower in the direction of 0 degrees than in the oblique direction. That is, when the luminance of the reflected light Rs1 in the direction of 0 degrees of the first printed layer 5, that is, the luminance in the front view, is Ls1, and the luminance of the reflected light Rs2 in the oblique direction, that is, the luminance in the perspective view, is Ls2, Ls1<Ls2.

In addition, the amount of reflected light of the base material 2 constituted by a metal plate or the like is sufficiently larger than the amount of light reflected by the first printed layer 5. For example, when the luminance of the reflected light Ru1 in the direction of 0 degrees of the base material 2, that is, the luminance in the front view is Lu1, Ls1<<Lu1.

Thus, the amount of light reflected from the base material 2 is sufficiently large, and thus the pattern shape 21 formed at the surface of the base material 2 is likely to be visually recognized in the front view. On the other hand, the amount of light reflected from the first printed layer 5 is relatively small, and thus the pattern shape 51 of the first printed layer 5 is less likely to be visually recognized in the front view.

In addition, the luminance Lu2 of the reflected light Ru2 in the oblique direction of the base material 2 becomes lower than the luminance Lu1 of the reflected light Ru1 in the direction of 0 degrees. That is, Lu1>Lu2. This is because light reflected in the oblique direction in the base material 2 is weakened due to reflection between the base material 2 and the first light-transmissive layer 3, attenuation due to irregularities of the surface of the base material 2, or the like. For this reason, the amount of light reflected obliquely by the first printed layer 5 becomes relatively large, and the pattern shape 51 of the first printed layer 5 is likely to be visually recognized. That is, when the luminance of the reflected light Rs2 in the oblique direction of the first printed layer 5 is Ls2, and the luminance of the reflected light Ru2 in the oblique direction of the base material 2 is Lu2, Ls2<Lu2, but a difference in luminance therebetween becomes smaller than a difference in luminance between Ls1 and Lu1.

For this reason, in a case where Ls2/Lu2>Ls1/Lu1, and the dial 1 is viewed from the oblique direction, the luminance of the first printed layer 5 becomes relatively higher than the luminance of the base material 2 as compared to a case where the dial 1 is viewed in the front view, and thus the pattern shape 51 of the first printed layer 5 is likely to be visually recognized.

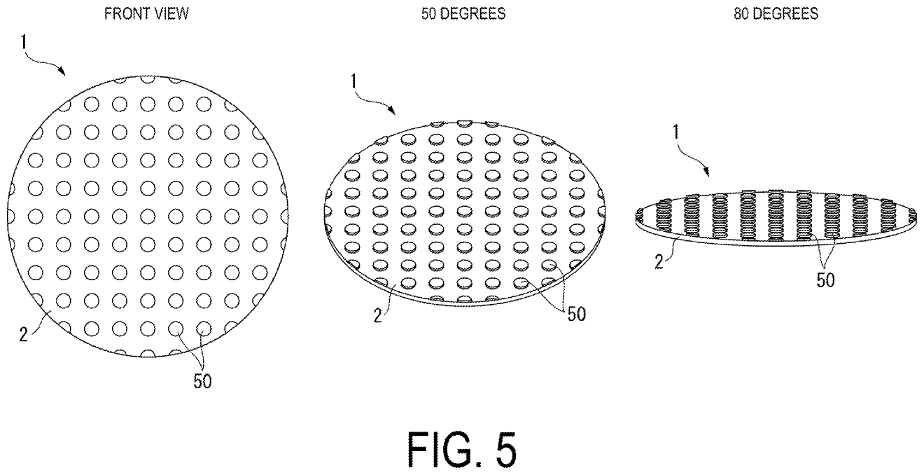

Further, as illustrated in FIG. 5, when comparing the case of the front view of the dial 1 when viewed from the direction of 0 degrees orthogonal to the surface of the dial 1, the case of the perspective view of 50 degrees when viewed from the oblique direction of 50 degrees with respect to the orthogonal direction, and the case of the perspective view of 80 degrees when viewed from the oblique direction of 80 degrees, an exposed area of the ink 50 with respect to an exposed area of the base material 2 is the smallest in the case of the front view, and is the greatest in the case of 80 degrees. For this reason, in the case of 80 degrees, the pattern shape 51 of the first printed layer 5 is more likely to be visually recognized compared to the front view.

At this time, an interval between dots of the ink 50 forming the pattern shape 51 of the first printed layer 5 is preferably larger than one time and smaller than three times the diameter of the dot. That is, in a case where the interval between the dots is equal to or less than one time the diameter of the dot, the interval between the dots is small, and thus it is difficult to visually recognize the pattern shape 21 of the base material 2 particularly when non-transparent ink is used. On the other hand, in a case where the interval between the dots is equal to or greater than three times the diameter of the dot, the interval between the dots is large, and thus the pattern shape 51 may become unclear because the dots are separated from each other even when the dial 1 is viewed in a perspective view. On the other hand, when the interval between the dots is made to be greater than once and smaller than three times the diameter of the dot, it is possible to visually recognize the pattern shape 21 of the base material 2 when the dial 1 is viewed in a front view and to clearly visually recognize the pattern shape 51 of the first printed layer 5 when the dial 1 is viewed in a perspective view.

Note that an angle at which the pattern shape 51 of the first printed layer 5 is clearly visually recognized when the dial 1 is viewed in a perspective view is influenced by an interval between the dots. For example, the example illustrated in FIG. 5 shows a case where the interval between the dots is twice the diameter of the dot. In this case, when viewed from an angle of 50 degrees or more with respect to the orthogonal direction, the pattern shape 51 of the first printed layer 5 tends to be viewed clearly. Further, in a case where the interval between the dots is once the diameter of the dot, the pattern shape 51 of the first printed layer 5 tends to be viewed clearly when viewed from an angle of 30 degrees or more with respect to the orthogonal direction, and in a case where the interval between the dots is three times the diameter of the dot, the pattern shape 51 of the first printed layer 5 tends to be viewed clearly when viewed from an angle of 70 degrees or more with respect to the orthogonal direction. That is, when the interval between the dots with respect to the diameter of the dot decreases, the pattern shape 51 of the first printed layer 5 becomes clear even when the angle of the dial 1 in a perspective view with respect to the orthogonal direction is small. When the interval between the dots increases, the pattern shape 51 of the first printed layer 5 does not become clear when the angle of the dial 1 in a perspective view with respect to the orthogonal direction is not large.

Note that the first light-transmissive layer 3 and the first liquid repellent layer 4 formed at the surface of the base material 2 may be formed at the entire surface of the base material 2 or may be partially formed. In addition, the first printed layer 5 formed at the surface of the first liquid repellent layer 4 may be formed at the entire surface of the first liquid repellent layer 4, or may be partially formed.

### Effects of First Embodiment

According to the present embodiment, the first liquid repellent layer 4 is formed by performing a liquid repellent treatment on the surface of the first light-transmissive layer 3 in the dial 1 for a timepiece, and thus the ink 50 ejected by an inkjet method and landed on the first liquid repellent layer 4 does not spread so much and can be attached with a stable diameter, and the pattern shape 51 of the first printed layer 5 can be expressed sharply. In addition, since the ink 50 of the first printed layer 5 is not absorbed by the first light-transmissive layer 3, a distance can be taken between the first printed layer 5 and the base material 2, and a pattern shape is formed in each of the first printed layer 5 and the base material 2. Thus, it is possible to express a complex design having a stereoscopic effect and a depth in the dial 1 and to improve design properties of the dial 1.

Additionally, the pattern shape 21 of the surface of the base material 2 can be easily visually recognized particularly when the dial 1 is viewed in a front view, and the pattern shape 51 of the first printed layer 5 with the dot pattern can be easily visually recognized when the dial 1 is viewed in a perspective view. Thus, it is possible to express designs varying depending on an angle at which the dial 1 of the timepiece is viewed.

Additionally, when the dial 1 is viewed in a front view, the pattern shape 51 of the first printed layer 5 is less likely to be visually recognized, and thus it is possible to prevent a pointer of the timepiece from being less likely to be visually recognized due to the pattern shape 51 of the first printed layer 5. When the dial 1 is viewed in a perspective view, the necessity of confirming the pointer of the timepiece is low, and thus the pattern shape 51 of the first printed layer 5 is likely to be confirmed, and it is possible to improve the design properties of the dial 1 and to increase an emotional value for a user.

A resin containing an acrylic resin or an epoxy resin is used as a light-transmissive resin, and thus it is possible to protect the base and the like of the base material 2 which are covered with the light-transmissive resin.

Further, in a case where the light-transmissive resin is ejected by an inkjet method to form the first light-transmissive layer 3, an ejection position and an ejection amount of the light-transmissive resin can be controlled at higher accuracy than in a case where the first light-transmissive layer 3 is formed by spaying. For this reason, it is possible to eject the light-transmissive resin to only a location where the first light-transmissive layer 3 is required in the base material 2, to minimize the amount of light-transmissive resin used, and to reduce costs.

Further, in a production line for the dial 1, an inkjet printer for ejecting a light-transmissive resin to form the first light-transmissive layer 3 and an inkjet printer for ejecting the ink 50 to form the first printed layer 5 are provided, and thus it is possible to easily automate the first light-transmissive layer formation step S2 and the first printed layer formation step S4 and to improve productivity.

### Second Embodiment

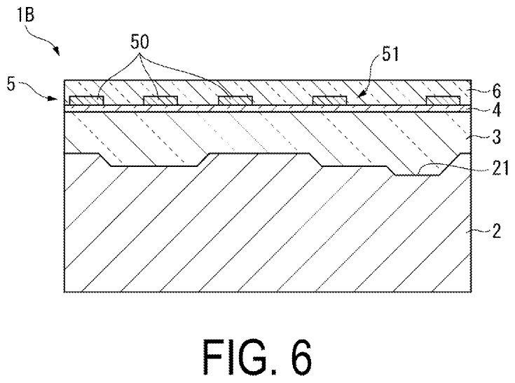

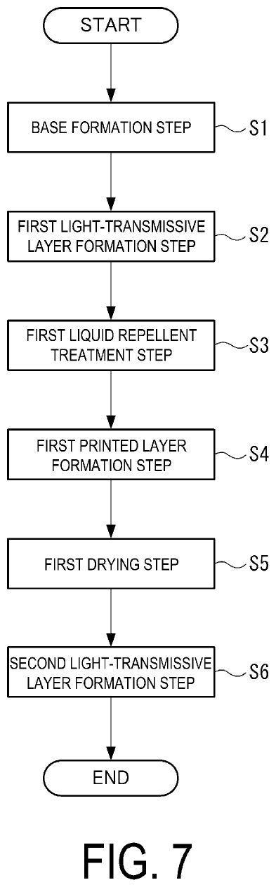

A timepiece component decoration method and a timepiece component according to a second embodiment will be described with reference to FIGS. 6 and 7. Note that, in the second embodiment, the same components as those in the first embodiment will be denoted by the same reference numerals and signs, and description thereof will be omitted or simplified.

FIG. 6 is a cross-sectional view illustrating a dial 1B which is an example of a timepiece component. The dial 1B includes a base material 2 constituted by a metal plate, a first light-transmissive layer 3 layered on the surface of the base material 2, a first liquid repellent layer 4 formed by performing a liquid repellent treatment on the surface of the first light-transmissive layer 3, a first printed layer 5 formed at the surface of the first liquid repellent layer 4 using ink 50 ejected by an inkjet method, and a second light-transmissive layer 6 layered on the surface of the first printed layer 5. That is, the dial 1B is configured by further layering the second light-transmissive layer 6 on the surface of the dial 1 according to the first embodiment.

Next, a method of decorating the dial 1B will be described with reference to a flowchart of FIG. 7.

In the flowchart of FIG. 7, a base formation step S1 to a first drying step S5 are the same as those in the first embodiment, and thus description thereof will be omitted. Further, in the second embodiment, after the first drying step S5 is performed, a second light-transmissive layer formation step S6 for applying a light-transmissive resin onto the surface of the first printed layer 5 to form the second light-transmissive layer 6 is performed. Similarly to the first light-transmissive layer 3, as the light-transmissive resin forming the second light-transmissive layer 6, an acrylic resin, an epoxy resin, or the like can be used, and resin materials such as transparent, pearlescent, and colored transparent resin materials can be used.

In the second light-transmissive layer formation step S6, similarly to the first light-transmissive layer formation step S2, a method of applying a light-transmissive resin by spraying, a method of ejecting and applying a light-transmissive resin by an inkjet method, or the like can be used as a method of applying the light-transmissive resin. Similarly to the first light-transmissive layer 3, a thickness dimension of the second light-transmissive layer 6 is, for example, 40 μm or more and 100 μm or less.

### Effects of Second Embodiment

According to the dial 1B, the base material 2, the first light-transmissive layer 3, the first liquid repellent layer 4, and the first printed layer 5, which are the same as those of the dial 1, are provided, and thus it is possible to exhibit the same operational effect as those in the first embodiment.

Further, since the second light-transmissive layer 6 is formed at the surface of the first printed layer 5, it is possible to protect the first printed layer 5 by the second light-transmissive layer 6 and to improve environmental resistance.

### Third Embodiment

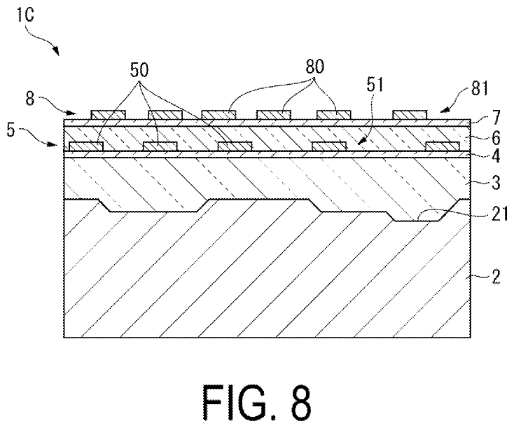

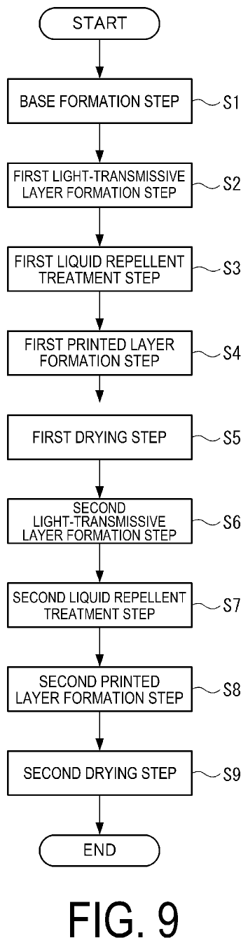

A timepiece component decoration method and a timepiece component according to a third embodiment will be described with reference to FIGS. 8 and 9. Note that, in the third embodiment, the same components as those in the first and second embodiments will be denoted by the same reference numerals and signs, and description thereof will be omitted or simplified.

FIG. 8 is a cross-sectional view illustrating a dial 1C which is an example of a timepiece component. The dial 1C includes a base material 2 constituted by a metal plate, a first light-transmissive layer 3 layered on the surface of the base material 2, a first liquid repellent layer 4 formed by performing a liquid repellent treatment on the surface of the first light-transmissive layer 3, a first printed layer 5 formed at the surface of the first liquid repellent layer 4 using ink 50 ejected by an inkjet method, and a second light-transmissive layer 6 layered on the surface of the first printed layer 5, a second liquid repellent layer 7 formed at the surface of the second light-transmissive layer 6 by performing a liquid repellent treatment, and a second printed layer 8 formed at the surface of the second liquid repellent layer 7. That is, the dial 1C is configured by further layering the second liquid repellent layer 7 and the second printed layer 8 on the surface of the dial 1B according to the second embodiment. The second printed layer 8 is formed by changing the density of dots of ink 80 and printing a pattern shape 81.

Next, a method of decorating the dial 1C will be described with reference to a flowchart of FIG. 9.

In the flowchart of FIG. 9, a base formation step S1 to a second light-transmissive layer formation step S6 are the same as those in the second embodiment, and thus description thereof will be omitted. Further, in the third embodiment, after the second light-transmissive layer formation step S6 is performed, a second liquid repellent treatment step S7, a second printed layer formation step S8, and a second drying step S9 are sequentially performed.

Similarly to the first liquid repellent treatment step S3, in the second liquid repellent treatment step S7, the second liquid repellent layer 7 is formed by performing a liquid repellent treatment on the surface of the second light-transmissive layer 6.

Similarly to the first printed layer formation step S4, in the second printed layer formation step S8, the second printed layer 8 is formed by ejecting the ink 80 onto the surface of the second liquid repellent layer 7 by an inkjet method and printing the pattern shape 81.

Similarly to the first drying step S5, in the second drying step S9, the ink 80 of the second printed layer 8 is dried.

Note that the pattern shapes 51 and 81 of the first printed layer 5 and the second printed layer 8 may be the same pattern shapes or may be different pattern shapes.

### Effects of Third Embodiment

According to the dial 1C, the base material 2, the first light-transmissive layer 3, the first liquid repellent layer 4, the first printed layer 5, and the second light-transmissive layer 6, which are the same as those of the dial 1B, are provided, and thus it is possible to exhibit the same operational effect as those in the first and second embodiments.

Further, since the second liquid repellent layer 7 is formed at the surface of the second light-transmissive layer 6, and the second printed layer 8 is formed at the surface of the second liquid repellent layer 7, the pattern shapes 21, 51, and 81 formed in the base material 2, the first printed layer 5, and the second printed layer 8 are expressed in an overlapping manner, and thus it is possible to express a complex design having a stereoscopic effect and a depth.

In addition, since the second liquid repellent layer 7 is formed at the surface of the second light-transmissive layer 6, and the second printed layer 8 is formed at the surface of the second liquid repellent layer 7, the ink 80 that has landed on the second liquid repellent layer 7 can be attached with a stable diameter without spreading so much similar to the first printed layer 5, and the pattern shape 81 of the second printed layer 8 can be expressed sharply. In addition, since a distance can be taken between the second printed layer 8 and the first printed layer 5, and a pattern shape is formed in each of the first printed layer 5 and the second printed layer 8, it is possible to express a complex design having a stereoscopic effect and a depth in the dial 1C and to improve design properties of the dial 1C.

### Other Embodiments

Note that the present disclosure is not limited to the embodiments described above, and various modifications can be made within the scope of the present disclosure.

For example, the timepiece components are not limited to the dials 1, 1B, and 1C, and various components that can be visually recognized from the outside, such as a date indicator, a day indicator, pointers such as hour, minute, and second hands, and a moon phase indicator, may be used. In addition, the timepiece components may be timepiece exterior components, for example, a case, a back lid, a bezel, and the like. Further, the timepiece components may be used for skelton type timepieces, or may be a ground plate, a rotational weight, a balance, an pallet, a gear, and the like that can be visually recognized from the outside.

The layer configurations of the timepiece components are not limited to the above-described embodiments. For example, the dial 1C may be configured such that a light-transmissive resin is layered on the surface of the second printed layer 8 to protect the second printed layer 8. That is, the number of printed layers and the number of light-transmissive layers may be appropriately set in accordance with specifications required for a target timepiece component, or the like.

lyophilic treatment may be performed before the liquid repellent treatment is performed on the surface of the first light-transmissive layer 3 and the second light-transmissive layer 6. The lyophilic treatment can be executed, for example, by emitting ultraviolet light, using atmospheric plasma using oxygen gas, or the like. By performing the lyophilic treatment, the surfaces of the first light-transmissive layer 3 and the second light-transmissive layer 6 can be cleaned, and thus the first liquid repellent layer 4 and the second liquid repellent layer 7 can be formed uniformly by the liquid repellent treatment.

The thickness dimensions of the first light-transmissive layer 3 and the second light-transmissive layer 6 may be set appropriately in practice. Distances of the pattern shape 21 of the base material 2, the pattern shape 51 of the first printed layer 5, and the pattern shape 81 of the second printed layer 8 change depending on the thickness dimensions of the first light-transmissive layer 3 and the second light-transmissive layer 6, and thus a stereoscopic effect and a feeling of depth can be adjusted.

### Summary of Present Disclosure

A timepiece component decoration method according to the present disclosure includes a base formation step of forming a pattern shape on a base material of a timepiece component and using the pattern shape as a base, a first light-transmissive layer formation step of forming, on a surface of the base, a first light-transmissive layer using a light-transmissive resin, a first liquid repellent treatment step of performing a liquid repellent treatment on a surface of the first light-transmissive layer, and a first printed layer formation step of, to form a first printed layer, ejecting ink and printing a pattern shape by an inkjet method on the surface of the first light-transmissive layer on which the liquid repellent treatment was performed, after the first liquid repellent treatment step.

According to the present disclosure, the liquid repellent layer is formed by performing a liquid repellent treatment on the surface of the first light-transmissive layer, and the first printed layer is formed by ejecting ink onto the liquid repellent layer by an inkjet method. Thus, ink droplets having landed on the liquid repellent layer not spread so much and can be attached to the liquid repellent layer with a stable diameter, and the pattern shape of the first printed layer can be expressed sharply. In addition, since the ink droplets of the first printed layer are not absorbed by the first light-transmissive layer, a distance can be taken between the first printed layer and the base layer, and a pattern shape can be formed in each of the first printed layer and the base layer. Thus, it is possible to express a complex design having a stereoscopic effect and a depth in a timepiece component such as a dial, and to improve design properties of the timepiece component.

In the timepiece component decoration method according to the present disclosure, it is preferable that the first light-transmissive layer formation step include ejecting the light-transmissive resin by an inkjet method to form the first light-transmissive layer.

According to the present disclosure, the light-transmissive resin is ejected by an inkjet method to form the first light-transmissive layer, and thus an ejection position and an ejection amount of the light-transmissive resin can be controlled at higher accuracy than in a case where a resin is ejected by spraying. For this reason, it is possible to eject the light-transmissive resin to only a location where the first light-transmissive layer is required in the base layer, to minimize the amount of light-transmissive resin used, and to reduce costs.

Additionally, in a production line for the timepiece component, an inkjet printer for ejecting a light-transmissive resin to form the first light-transmissive layer and an inkjet printer for ejecting ink to form the first printed layer are provided, and thus it is possible to easily automate the first light-transmissive layer formation step and the first printed layer formation step and to improve productivity.

It is preferable that the timepiece component decoration method according to the present disclosure further include a second light-transmissive layer formation step of, to form a second light-transmissive layer, layering a light-transmissive resin on a surface of the first printed layer, after the first printed layer formation step.

According to the present disclosure, the second light-transmissive layer is layered on the surface of the first printed layer, and thus the first printed layer can be protected.

It is preferable that the timepiece component decoration method according to the present disclosure further include a second liquid repellent treatment step of performing a liquid repellent treatment on a surface of the second light-transmissive layer after the second light-transmissive layer formation step, and a second printed layer formation step of, to form a second printed layer, ejecting ink and printing a pattern shape by an inkjet method on the surface of the second light-transmissive layer on which the liquid repellent treatment was performed, after the second liquid repellent treatment step.

According to the present disclosure, the second printed layer is layered on the first printed layer with the second light-transmissive layer interposed therebetween, and thus a distance can be taken between the second printed layer and the first printed layer, and a pattern shape can be formed in each of the first printed layer and the second printed layer. Thus, it is possible to express a complex design having a stereoscopic effect and a depth in a timepiece component and to improve design properties of the timepiece component.

In the timepiece component decoration method according to the present disclosure, it is preferable that the light-transmissive resin be a resin containing an acrylic resin or an epoxy resin.

According to the present disclosure, a resin containing an acrylic resin or an epoxy resin is used as a light-transmissive resin, and thus it is possible to protect the base layer, the first printed layer, and the like which are covered with the light-transmissive resin.

A timepiece component of the present disclosure includes a base material having a pattern shape serving as a base formed at a surface thereof, a first light-transmissive layer formed of a light-transmissive resin on the surface of the base material, a first liquid repellent layer formed by performing a liquid repellent treatment on a surface of the first light-transmissive layer, and a first printed layer in which a pattern shape is printed on a surface of the first liquid repellent layer by an inkjet method.

According to the present disclosure, the liquid repellent layer is formed by performing a liquid repellent treatment on the surface of the first light-transmissive layer, and the first printed layer is formed by ejecting ink onto the liquid repellent layer by an inkjet method. Thus, ink droplets having landed on the liquid repellent layer not spread so much and can be attached to the liquid repellent layer with a stable diameter, and the pattern shape of the first printed layer can be expressed sharply. In addition, since the ink droplets of the first printed layer are not absorbed by the first light-transmissive layer, a distance can be taken between the first printed layer and the base layer, and a pattern shape can be formed in each of the first printed layer and the base layer. Thus, it is possible to express a complex design having a stereoscopic effect and a depth in a timepiece component such as a dial, and to improve design properties of the timepiece component.

It is preferable that the timepiece component of the present disclosure further include a second light-transmissive layer formed from a light-transmissive resin on a surface of the first printed layer.

According to the present disclosure, the second light-transmissive layer is layered on the surface of the first printed layer, and thus the first printed layer can be protected.

It is preferable that the timepiece component of the present disclosure further include a second liquid repellent layer formed by performing a liquid repellent treatment on a surface of the second light-transmissive layer, and a second printed layer formed by printing a pattern shape on a surface of the second liquid repellent layer by an inkjet method.

According to the present disclosure, the second printed layer is layered on the first printed layer with the second light-transmissive layer interposed therebetween, and thus a distance can be taken between the second printed layer and the first printed layer, and a pattern shape can be formed in each of the first printed layer and the second printed layer. Thus, it is possible to express a complex design having a stereoscopic effect and a depth in a timepiece component and to improve design properties of the timepiece component.

What is claimed is:

1. A timepiece component decoration method, comprising:
a base formation step of forming a pattern shape on a base material of a timepiece component and using the pattern shape as a base;
a first light-transmissive layer formation step of forming, on a surface of the base, a first light-transmissive layer using a light-transmissive resin;
a first liquid repellent treatment step of performing a liquid repellent treatment on a surface of the first light-transmissive layer; and
a first printed layer formation step of, to form a first printed layer, ejecting ink and printing a pattern shape by an inkjet method on the surface of the first light-transmissive layer on which the liquid repellent treatment was performed, after the first liquid repellent treatment step.

2. The timepiece component decoration method according to claim 1, wherein
the first light-transmissive layer formation step includes ejecting the light-transmissive resin by an inkjet method to form the first light-transmissive layer.

3. The timepiece component decoration method according to claim 1, further comprising
a second light-transmissive layer formation step of, to form a second light-transmissive layer, layering a light-transmissive resin on a surface of the first printed layer, after the first printed layer formation step.

4. The timepiece component decoration method according to claim 3, further comprising:
a second liquid repellent treatment step of performing a liquid repellent treatment on a surface of the second light-transmissive layer after the second light-transmissive layer formation step; and
a second printed layer formation step of, to form a second printed layer, ejecting ink and printing a pattern shape by an inkjet method on the surface of the second light-transmissive layer on which the liquid repellent treatment was performed, after the second liquid repellent treatment step.

5. The timepiece component decoration method according to claim 1, wherein
the light-transmissive resin is a resin containing an acrylic resin or an epoxy resin.

6. A timepiece component, comprising:
a base material having a surface on which a pattern shape used as a base is formed;
a first light-transmissive layer formed from a light-transmissive resin on the surface of the base material;
a first liquid repellent layer formed by performing a liquid repellent treatment on a surface of the first light-transmissive layer; and
a first printed layer formed by printing a pattern shape on a surface of the first liquid repellent layer by an inkjet method.

7. The timepiece component according to claim 6, further comprising
a second light-transmissive layer formed from a light-transmissive resin on a surface of the first printed layer.

8. The timepiece component according to claim 7, further comprising:
a second liquid repellent layer formed by performing a liquid repellent treatment on a surface of the second light-transmissive layer; and
a second printed layer formed by printing a pattern shape on a surface of the second liquid repellent layer by an inkjet method.
